(19) United States
(12) Patent Application Publication
(10) Pub. No.: US 2014/0032379 A1
(43) Pub. Date: Jan. 30, 2014

(54) ON-SHELF AVAILABILITY SYSTEM AND METHOD

(71) Applicants: Wolfgang Schuetz, Konstanz (DE); Igor Martic, Taegerwilen (DE)

(72) Inventors: Wolfgang Schuetz, Konstanz (DE); Igor Martic, Taegerwilen (DE)

(21) Appl. No.: 13/655,879

(22) Filed: Oct. 19, 2012

Related U.S. Application Data
(60) Provisional application No. 61/676,498, filed on Jul. 27, 2012.

(51) Int. Cl. G06Q 10/08

(52) U.S. Cl. CPC G06Q 10/087
USPC 705/28

(57) ABSTRACT

Systems and methods to determine on-shelf availability are provided. In example embodiments, transaction data that includes past sales transactions is accessed. A virtual time scale is determined. The virtual time scale is based on a transformation of the transaction data for a particular product category from a real-time scale to the virtual time scale that provides uniformly distributed sales. At least one estimation parameter of an exponential function based on the virtual time scale and the transaction data is determined. Using the at least one estimation parameter, current sales transaction data is monitored to detect a critical time that indicates a high probability that the particular product category will be out-of-shelf.

### CLAIM OF PRIORITY

The present patent application claims the priority benefit of the filing date of U.S. provisional application No. 61/676,498 filed Jul. 27, 2012, the entire content of which is incorporated herein by reference.

### FIELD

The present disclosure relates generally to data analysis, and in a specific example embodiment, to data analysis to determine on-shelf availability.

### BACKGROUND

Generally, retailers have poor visibility of on-shelf availability within their stores. This will result in lost revenue and customers. Typically, there are two root causes that effect on-shelf availability. The first cause is a wrong ordering of products, which may be based on wrong system inventories or human error. The second cause is a weak in-store process of getting the products to the shelf. The weak in-store process may be affected by delayed shelf replenishment, cluttered shelves, or undetected wrong system inventory.

### BRIEF DESCRIPTION OF DRAWINGS

Various ones of the appended drawings merely illustrate example embodiments of the present invention and cannot be considered as limiting its scope.

FIG. 1 illustrates an environment in which example embodiments of the inventive subject matter may be practiced.

FIG. 2 is a block diagram illustrating the analysis server.

FIG. 3 is an illustration of an example time scale transformation.

FIG. 4 is a flowchart of an example method for determining on-shelf availability.

FIG. 5 is a flowchart of an example method for creating a virtual time scale.

FIG. 6 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Systems and methods for determining on-shelf availability are provided. Example embodiments take transaction data (e.g., sales transactions for a certain period of time) for a given product or product category and analyzes a length of each sales interval (e.g., time between two subsequent sales transaction of the product). Unusually long intervals may indicate potential shelf gaps (e.g., product is not on the shelf or cannot be sold). The length of the sales interval may be referred to as a wait time. Example embodiments further calculate a probability that a sales interval of an observed length occurs assuming there is a full shelf availability as well as determines a critical time in the future when the product may most likely be out-of-shelf. Influencing factors, such as price, discounts, and promotions as well as trends may be modeled into the calculations.

In example embodiments, transaction data that includes past sales transactions is accessed. The processing of transaction data may occur in a virtual (e.g., artificial time scale). Accordingly, transaction data is pre-processed to transform the sales transaction time into the virtual time scale. This transformation may be based on an assumption of having a constant sales probability (e.g., uniform distributed sales) fulfilled.

At least one estimation parameter of an exponential function or distribution based on the virtual time scale and the transaction data is determined. Using the at least one estimation parameter, current sales transaction data is monitored to detect a critical time that indicates a high probability that the particular product category will be out-of-shelf. The detected critical time will be in the virtual time scale. The critical time may then be transformed back into real-time for output.

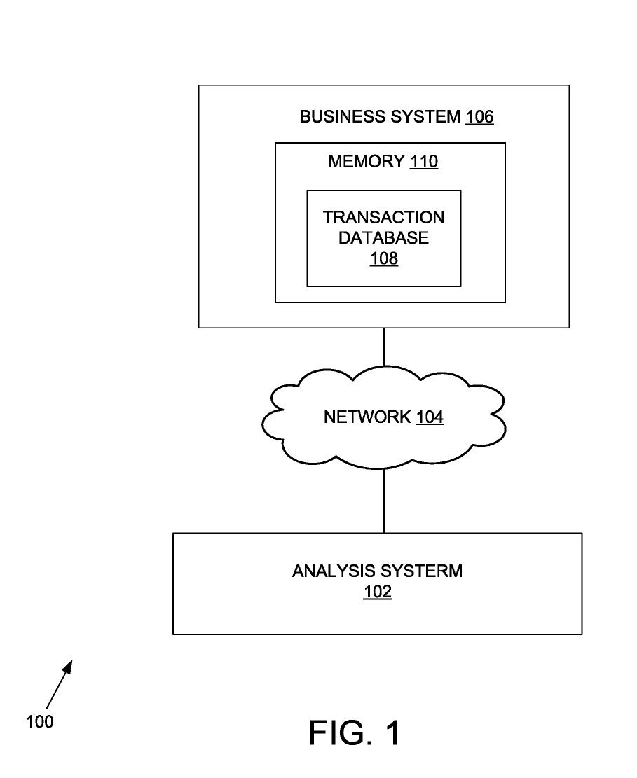

With reference to FIG. 1, an environment 100 in which example embodiments of the inventive subject matter may be practiced is shown. The environment 100 comprises an analysis system 102 communicatively coupled via a network 104 to a business system 106. The business system 106 may be located at a location of a business or customer (e.g. retail store) and manages transaction data specific to the business. In particular, the business system 106 comprises a transaction database 108 that stores transaction data for the business. The transaction data may include sale transactions for various products and product categories. In example embodiments, the business system 106 is embodied on a computing device such as a server.

In one embodiment, the business system 106 is linked via the network 104 with the analysis system 102 to allow the analysis system 102 to perform analysis on the transaction data and determine on-shelf availability for the business corresponding to the business system 106. The network 104 may comprise the Internet, a wireless network, a cellular network, a Wide Area Network (WAN), a local area network (LAN), or any other type of network which allows for exchange of communications. In an alternative embodiment, the analysis system 102 may be a part of (e.g., embodied within) the business system 106. For example, components of the analysis system 102 may be embodied within a memory 110 of the business system 102 that also stores the transaction database 108. This embodiment allows for fast in-memory processing and calculations. For example, the analysis system 102 may be implemented using an extended stored procedure technology (e.g., SAP HANA).

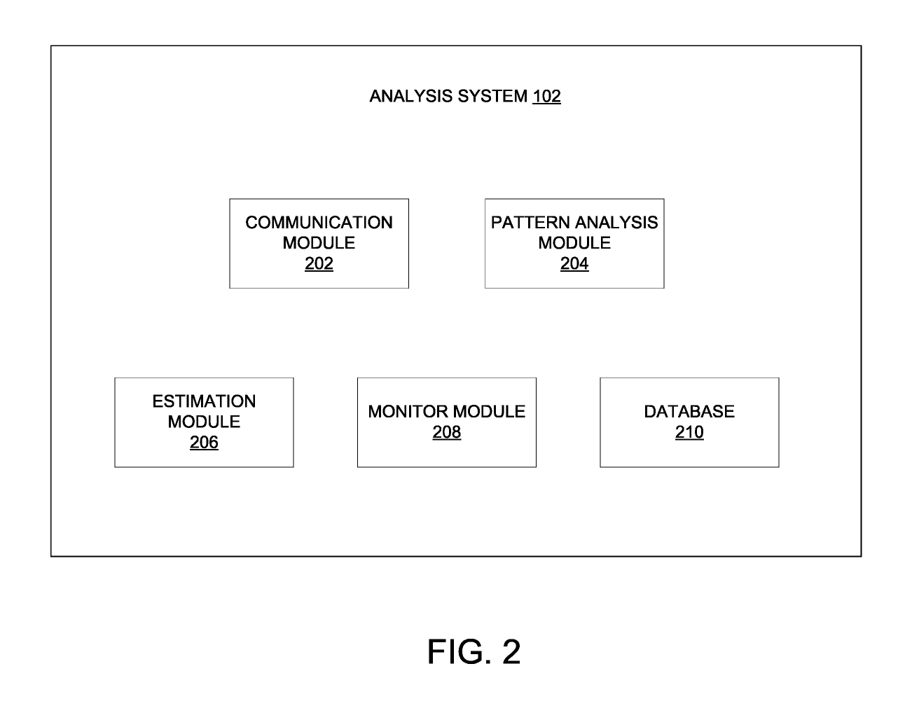

In one embodiment, the analysis system 102 may be a component of an on-demand system which is hosted by a service provider. The on-demand system comprises one or more network applications that provide services and support to a customer (e.g., business) without the customer having to host the system on their premises. That is, the service provider hosts (e.g., offers, provides, implements, executes, or performs one or more operations of) the systems and the customer can access functionalities online through a software-as-a-service (SaaS) model. The on-demand systems may include, for example, services and support for supply chain management, human resource management, customer relationship management (CRM), financial and accounting management, compliance management, supplier relationship management, software management, or any other form of management. In example embodiments, the analysis system 102 (and the on-demand system) may be embodied on one or more computing devices such as servers. The analysis system 102 will be discussed in more detail in connection with FIG. 2 below.

The environment 100 of FIG. 1 is merely an example, and alternative embodiments may comprise any number of business systems 106 communicatively coupled to any number of analysis systems 106. Furthermore, components and functions of the business system 106 and the analysis system 102 may be combined, separated, or located elsewhere in the environment 100. For example, the analysis system 102 may be located within the business system 106 and exchange data via a local area network (LAN).

FIG. 2 is a block diagram illustrating the analysis system 102 in further detail. The analysis system 102 is configured to analyze transaction data to determine on-shelf availability for the business. As such, the analysis system 102 may facilitate proper ordering of products and placement of product on the shelf at an appropriate time. Accordingly, the analysis system 102 may comprise a communication module 202, a pattern analysis module 204, an estimation module 206, a monitor module 208, and a database 210, all of which may be communicatively coupled together.

The communication module 202 exchanges data with various entities via the network 104 including the business system 106. In example embodiments, the communication module 202 receives transaction data from the business system 106. The transaction data includes sales transaction information for a particular period of time. The transaction data may be obtained in batch form or be streamed in real-time. The received transaction data may be locally stored to the database 210 of the analysis system 102.

The communication module 202 also receives merchandise hierarchy information for the business. The merchandise hierarchy is a master data set that defines groups of products (e.g., categories). In various embodiments, the sales transaction data indicates individual products that were transacted (e.g., sold). The merchandise hierarchy provides guidance as to the category that each individual product is associated with. Generally, the analysis performed by the analysis system 102 for pattern analysis is performed on a category basis. However, fast moving products may be analyzed on an individual product basis. The analysis is discussed in further detail below.

Additionally, the communication module 202 may receive demand influencing factors from the business system 106. In alternative embodiments, the demand influencing factors may be determined from transaction data by, for example, the estimation module 206. The demand influencing factors comprise data regarding events that may affect sales for a product or product category. The demand influencing factors may include, for example, price, discounts, and promotions. A further demand influencing factor may be a trend. Data regarding public holidays (e.g., causing store closing or higher customer traffic) may also be received from the business system 106 by the communication module 202.

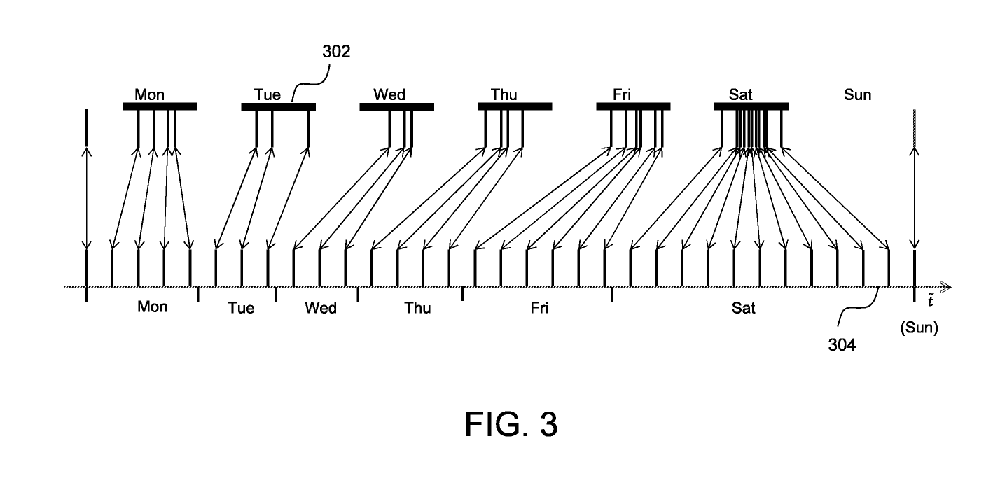

The pattern analysis module 204 performs pre-processing of past transaction data to determine a virtual time scale (e.g., an intraweek pattern) that models regular, recurring intraweek and intraday sales fluctuations on individual products or product categories. For fast selling products, pattern analysis may be applied to individual products of the location (e.g., retail location of the business). However, for most products, pattern analysis may be applied on a product category level. The process performed by the pattern analysis module 204 results in a virtual “linearized” time scale where sales transactions have a same probability throughout the week. This process may be performed, for example, once a week. The virtual time scale may be stored to the database 210 for use by the monitor module 208. The pattern analysis process will be discussed in more detail in connection with FIG. 3.

The estimation module 206 estimates parameters for a probability distribution of wait times that include a base estimation as well as the effects of trends and demand influencing factors. In one example, the estimation process may be performed once a day. In example embodiments, the estimation module 206 takes the virtual time scale determined by the pattern analysis module 204 and determines a model which defines transaction attributes to be used as influencing factors and how to apply the influencing factors when modeling sales intervals (e.g., time between two subsequent sales transactions of the same product in the same store). The influencing factors may include price, discount, promotions, trends, or any combination of these. The results of the estimation process may be stored to the database 210. In example embodiments, the processing by the estimation module 206 is performed on a single product/single location level.

In a simplified model, transaction times tᵢ are uniformly distributed over a total time period, t˜U(t_{inf}, tₛᵤₚ). That is, sales of a given product have equal probability of being transacted at any time while ignoring intraweek sales patterns, price, promotion, discount, seasonality, and trend. The exponentially distributed wait time is t_{L}˜Exp(λ) and a probability density function is f_{λ}(t_{L})=λe^{-λt}^{_{L}} where λ can be calculated from the sample average wait time t̅_{L} as λ=1/ t̅_{L}.

A cumulative distribution function may be computed as F_{λ}( [symbol] )=∫ [symbol] f_{λ}(t_{L})dt_{L}=1−e^{-λ} [symbol] , which indicates a probability that the wait time t_{L} is smaller than some given upper limit [symbol] , which may be configurable. Given a probability threshold (quantile) q of, for example, 99%, the corresponding critical wait time [symbol] may be calculated as

$$1 - {e}^{- {λℱ}_{L}} = q = 0.99$$

$${ℱ}_{L} = - \frac{1}{λ} ln ( 1 - q ) = - \frac{1}{λ} ln 0.99 .$$

Wait times that exceed this value should occur in approximately 1% of all cases.

In example embodiments, changing influencing factors affect the probability that at every point in time, a product can be sold. For example, promotions (e.g., sales) may be offered, prices may change, and discounts may be applied. These influencing factors should be incorporated into the model. In an exponential distribution equation, a parameter λ is utilized that refers to a rate of false alerts that are defined to be acceptable. Furthermore, a linear model in λ is established that is used in estimation in these parameters assuming a simple linear model, such as, λ=λ(i)=λ₀+λₚpᵢ+λ_{d}dᵢ+λₓxᵢ. A base λ (e.g., λ₀) is a general characteristic of the exponential function. Price, discount, and promotions are represented in the equation by λₚpᵢ, λ_{d}dᵢ, and λₓxᵢ, respectively. The influencing factors vary with i and therefore vary over time. λ₀, λₚ, λ_{d}, and λₓ may be estimated from historical data and a Log-Likelihood Function, given historic wait times. For example, the function may be L(λ₀, λₚ, λ_{d}, λₓ|t_{L,i})=Σᵢ ln f(λ₀, λₚ, λ_{d}, λₓ|t_{L,i})=Max. The equation may be solved using a conjugate gradient method or a similar optimization method. The result indicates the influence of price, discount, promotions, and base effect which is used to monitor a current sales situation.

Additionally, trends may be incorporated (e.g., a characteristic which changes over time) into the model. Thus, the linear model may be extended to include a trend component: λ=λ(i)=λ₀+λₚpᵢ+λ_{d}dᵢ+λₓxᵢ+λ_{T}i, where is estimated together with λ₀, λₚ, λ_{d}, and λₓ by maximizing the Log-Likelihood Function. A similar extension may be applied to effects of seasonality.

The estimation module 206 may also detect promotion periods, unusually high sales, or outliers. Outliers are exceptionally long wait times that occurred in the past and may bias the results. These outliers may be removed and the processing performed to obtain a new model which can then be re-estimated. In another example, the estimation module 206 may analyze a series of past wait times and automatically detect trends in the sales levels of each product. Further still, unusually high sales (referred to as “boost”) are a series of fast outliers (e.g., periods in the past when the product sold faster than expected). The estimation module 206 may detect these boosts and remove them before modeling. The model may be extended by the boost effect according to λ=λ₀+λₚpᵢ+λ_{d}dᵢ+λₓxᵢ+λ_{T}i λ_{B}B(i), where B(i) is a dummy variable that becomes 1 if the period i belongs to a boost period that has been detected beforehand, and 0 otherwise.

The monitor module 208 applies the modeled parameters outputted by the estimation module 206 (and stored to the database 210) to current sales transaction to determine potential past shelf gaps and to determine products (or product categories) that are likely to be out-of-shelf now or in the near future. The monitoring process may be performed as frequently as needed and may be performed continuously (e.g., every five minutes). In example embodiments, the processing by the monitor module 208 is performed on a single product/single location level. In example embodiments, the monitor module 208 performs a comparison of current sales transaction with a calculated wait time to determine out-of-shelf probabilities for each sales interval. If the interval is short, the probability of a shelf gap may be low while a longer interval may have a higher probability. Using, a configurable probability threshold, the monitor module 208 calculates a point in time when the product will become critical (e.g., when the product may not be on the shelf).

Referring now to FIG. 3, an illustration of an example time scale transformation performed by the pattern analysis module 204 is shown. The pattern analysis module 204 performs a pre-processing analysis of transaction data (e.g., a batch of sales transactions) to generate a virtual time scale for use in the estimation and monitoring process. In example embodiments, the pattern analysis module 204 transforms real transaction times of past sales transactions into a virtual time scale in which sales for a product (or product category) for the store are uniform.

In the example shown in FIG. 3, a week of sales transactions are analyzed, although any length of time may be used. In one embodiment, if more than one week of data is used, only the time within the week is used for the analysis. Horizontal bars 302 at the top of FIG. 3 indicate store openings. As shown, the store is closed on Sunday and at night. A random sampling of sales transactions (e.g., 30 in the example) is received that reflects the inter-week and intraday pattern of sales. As shown, there are more sales on Saturday, less sales on Tuesday and Wednesday, and no sales at night when the store is closed.

A virtual time axis 304 that is the same length as the week is expanded having a same number of transactions (e.g., 30 in the example) that are uniformly positioned or distributed on the virtual time axis. A direct assignment of each transaction from a real-time axis (shown at the top) to the virtual time axis 304 is performed using linear interpolation. Thus, for example, virtual time runs slowly on Saturday because there is more traffic at the store, while virtual time runs fast during early morning hours during a weekday and may stop during the night when the store is closed. Therefore, the transformation of time is based on an interpolation rule. Once a transformation of the time information is determined, the transformation may be used to model sales transactions in a corresponding virtual time domain. As a result, a simple threshold may be applied by the monitor module 208 to determine on-shelf availability.

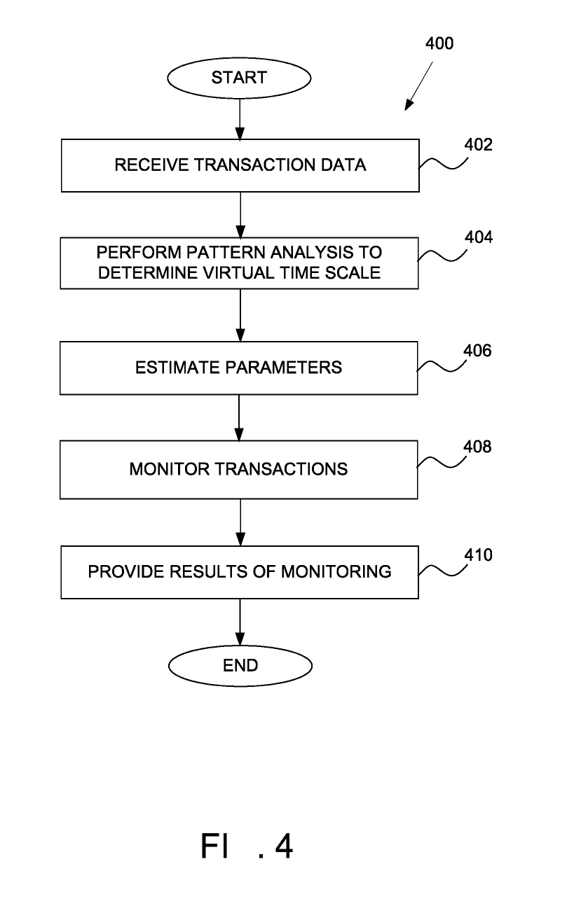

FIG. 4 is a flowchart of an example method 400 for determining on-shelf availability. In example embodiments, the method is performed by the analysis system 102.

In operation 402, the communication module 202 receives transaction data from the business system 106. The transaction data includes sales transaction information for a particular period of time. The transaction data may be obtained in batch form or be streamed in real-time. The received transaction data may be locally stored to the database 210 of the analysis system 102. Additionally, the communication module 202 may receive merchandise hierarchy information for the business that defines groups of products (e.g., categories). Furthermore, the communication module 202 may receive demand influencing factor data from the business system 106. The demand influencing factor data comprise data regarding events that may affect sales for a product or product category. Demand influencing factors may include, for example, price, discounts, and promotions. A further demand influencing factor may be a trend. Data regarding public holidays (e.g., causing store closing or higher customer traffic) may also be received from the business system 106 by the communication module 202.

Pattern analysis is performed in operation 404 to determine a virtual time scale. In example embodiments, the pattern analysis module 204 performs pre-processing of past transaction data to determine the virtual time scale (e.g., an intraweek pattern) that models regular, recurring intraweek and intraday sales fluctuations on individual products or product categories. The pattern analysis results in a virtual “linearized” time scale where sales transactions have a same probability throughout the week.

In operation 406, model parameters are estimated by the estimation module 206, which are parameters for a probability distribution of wait times that include a base estimation as well as the effects of trends and demand influencing factors. In example embodiments, the estimation module 206 takes the virtual time scale determined in operation 404 and determines a model which defines transaction attributes to be used as influencing factors and how to apply the influencing factors when modeling sales intervals (e.g., time between two subsequent sales transactions of the same product in the same store). The influencing factors may include price, discount, promotions, trends, or any combination of these. The results of the estimation process may be stored to the database 210.

In operation 408, transactions are monitored. In example embodiments, the monitor module 208 applies the modeled parameters determined in operation 406 to current sales transaction to determine products (or product categories) that are likely to be out-of-shelf now or in the near future. The current sales transaction data may have been accessed via the communication module 202 from the business system 106 at any time.

In example embodiments, the monitor module 208 performs a comparison of current sales transaction with a calculated wait time determined in operation 408 to determine out-of-shelf probabilities for each sales interval. Using, a configurable probability threshold, the monitor module 208 may calculate a point in time when the product will become critical (e.g. when the product may not be on the shelf). In example embodiments, the critical time is determined in the virtual time scale. As such, the monitoring module 208 will transform the critical time back to a real-time scale. The monitoring module 208 then provides or causes the provision of a report of the critical time back to the business.

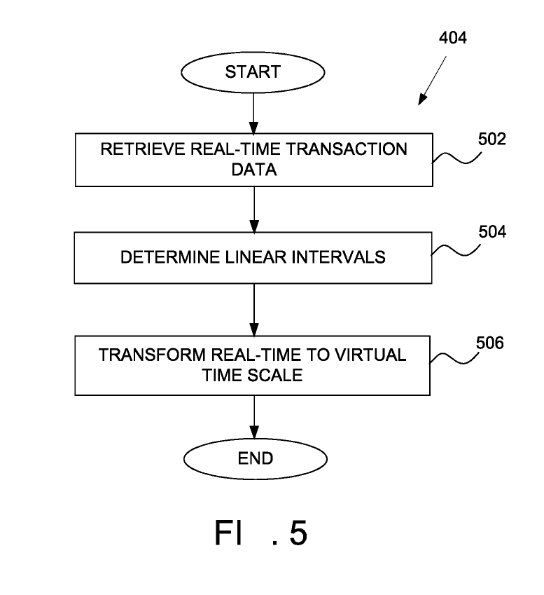

FIG. 5 is a flowchart of an example method for creating a virtual time scale (e.g., in operation 404). The method may be performed by the pattern analysis module 204 of the analysis system 102. In operation 502, real-time transaction data is retrieved by the pattern analysis module 204. In some embodiments, the real-time data may be have been received from the business system 102 by the communication module 202 and stored to the database 210. Subsequently, the pattern analysis module 204 accesses the stored transaction data.

In operation 504, linear intervals for a virtual time scale are determined. In example embodiments, the pattern analysis module 204 determines a number of transactions for a particular time period (e.g., week, two weeks, month) in the real-time scale and creates a virtual time axis that is the same length as the particular time period. The virtual time axis is expanded to have a same number of transactions that are uniformly positioned on the virtual time axis.

In operation 506, a transformation from the real-time scale to the virtual time axis (e.g., virtual time scale) is performed. In example embodiments, a direct assignment of each transaction from a real-time to the virtual time axis is performed using linear interpolation.

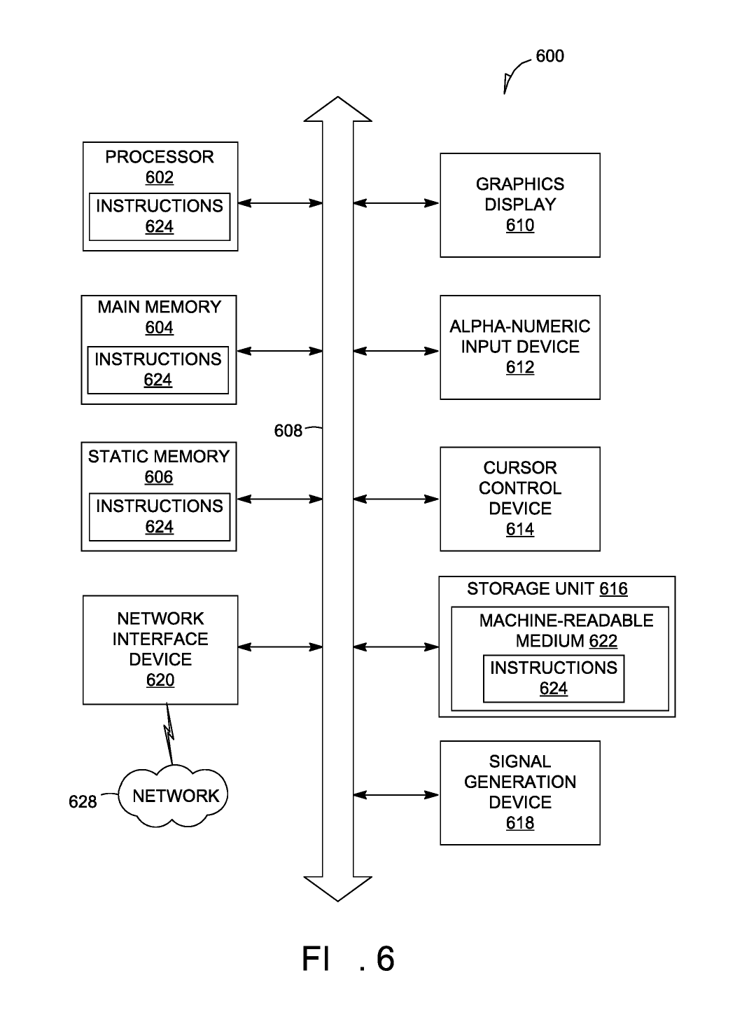

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system and within which instructions 624 (e.g., software, a program, an application, an applet, an app, or other executable code) for causing the machine 600 to perform any one or more of the methodologies discussed herein may be executed. In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alpha-numeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The instructions 624 may further be transmitted or received over a communications network 626 using a transmission medium via the network interface device 620 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
accessing transaction data that includes past sales transactions;
determining, using a processor of a machine, a virtual time scale based on a transformation of the transaction data for a particular product category from a real-time scale to the virtual time scale that provides uniformly distributed sales;
determining at least one estimation parameter of an exponential function based on the virtual time scale and the transaction data; and
using the at least one estimation parameter, monitoring current sales transaction data to detect a critical time that indicates a high probability that the particular product category will be out-of-shelf.

2. The method of claim 1, wherein the at least one estimation parameter is associated with an influencing factor that indicates events that affect sales for the particular product category.

3. The method of claim 2, wherein the influencing factor is selected from the group consisting of price, discount, and promotion.

4. The method of claim 2, further comprising identifying the influencing factor from the transaction data.

5. The method of claim 1, wherein the at least one estimation parameter is associated with a trend.

6. The method of claim 1, wherein the at least one estimation parameter is a base parameter that provides a general characteristic of the exponential function.

7. The method of claim 1, further comprising:
transforming the critical time back to the real-time scale; and
causing a report of the critical time to be presented to a business that provided the transaction data.

8. The method of claim 1, wherein the determining of the virtual time scale comprises:
determining a number of transactions in the real-time scale for over a period of time;
creating a virtual time axis that is the same length as the period of time;
expanding the virtual time axis to have the number of transactions uniformly positioned on the virtual time axis; and
directly assigning each transaction of the number of transactions from the real-time scale to the virtual time axis using linear interpolation.

9. The method of claim 1, wherein the particular product category is a particular product.

10. The method of claim 1, further comprising:
determining an outlier in the transaction data; and
removing the outlier prior to the determining of the at least one estimation parameter.

11. The method of claim 1, further comprising:
determining a boost in the transaction data; and
removing the boost prior to the determining of the at least one estimation parameter.

12. A machine-readable storage medium in communication with at least one processor, the non-transitory machine-readable storage medium storing instructions which, when executed by the at least one processor of a machine, cause the machine to perform operations comprising:
accessing transaction data that includes past sales transactions;
determining, using a processor of a machine, a virtual time scale based on a transformation of the transaction data for a particular product category from a real-time scale to the virtual time scale that provides uniformly distributed sales;
determining at least one estimation parameter of an exponential function based on the virtual time scale and the transaction data; and
using the at least one estimation parameter, monitoring current sales transaction data to detect a critical time that indicates a high probability that the particular product category will be out-of-shelf.

13. The machine-readable storage medium of claim 12, wherein the at least one estimation parameter is associated with an influencing factor that indicates events that affect sales for the particular product category.

14. The machine-readable storage medium of claim 13, wherein the influencing factor is selected from the group consisting of price, discount, and promotion.

15. The machine-readable storage medium of claim 12, wherein the at least one estimation parameter is associated with a trend.

16. The machine-readable storage medium of claim 12, wherein the operations further comprises:
transforming the critical time back to the real-time scale; and
causing a report of the critical time to be presented to a business that provided the transaction data.

17. The machine-readable storage medium of claim 12, wherein the determining of the virtual time scale comprises:
determining a number of transactions in the real-time scale for over a period of time;
creating a virtual time axis that is the same length as the period of time;
expanding the virtual time axis to have the number of transactions uniformly positioned on the virtual time axis; and
directly assigning each transaction of the number of transactions from the real-time scale to the virtual time axis using linear interpolation.

18. The machine-readable storage medium of claim 12, wherein the operations further comprise:
determining an outlier in the transaction data; and
removing the outlier prior to the determining of the at least one estimation parameter.

19. The machine-readable storage medium of claim 12, wherein the operations further comprise:
determining a boost in the transaction data; and
removing the boost prior to the determining of the at least one estimation parameter.

20. A system comprising:
a processor of a machine;
a pattern analysis module to access transaction data that includes past sales transactions and to determine, using the processor of the machine, a virtual time scale based on a transformation of the transaction data for a particular product category from a real-time scale to the virtual time scale that provides uniformly distributed sales;
an estimation module to determine at least one estimation parameter of an exponential function based on the virtual time scale and the transaction data; and
a monitoring module to monitor, using the at least one estimation parameter, current sales transaction data to detect a critical time that indicates a high probability that the particular product category will be out-of-shelf.
